(19) United States
(12) Patent Application Publication
(10) Pub. No.: US 2007/0168669 A1
(43) Pub. Date: Jul. 19, 2007

(54) Anti-tamper system

(75) Inventor: Brian D. Jonas, Troy, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Lockheed Martin Corporation

(21) Appl. No.: 11/331,504

(22) Filed: Jan. 13, 2006

(51) Int. Cl. H04L 9/00

(52) U.S. Cl. 713/176

(57) ABSTRACT

A system in accordance with the present invention prevents tampering of a device. The system includes an encrypted digital signature and a decryption attempt. The encrypted digital signature represents a configuration of the device and is retained in a non-volatile memory of the device. The decryption attempt is received from a source seeking access to the device. The system determines whether the digital signature matches the decryption attempt.

### FIELD OF INVENTION

The present invention relates to a system for preventing tampering, and more specifically, to a system for preventing tampering of data within a network.

### BACKGROUND OF THE INVENTION

Computer capabilities have increased dramatically in recent years. In addition to traditional computer applications such as word processing and spreadsheet calculations, modern personal computers (PCs) are typically capable of producing and playing multimedia presentations.

Multimedia applications may include materials such as audio, video, or graphic elements that are subject to copyright or contractual restrictions pertaining to use, distribution, etc. Typically, the multimedia contents are provided in digital form for use by computers or other digital consumer electronic (CE) devices.

Many content providers are reluctant to include valuable copyrighted material (e.g., full length motion pictures for use in multimedia applications) because the digital bitstream may be intercepted and copied. Unlike analog materials, which degrade in quality from one copied generation to the next, digital copying is capable of producing perfect copies regardless of how many generations of copies are produced.

Recent advances in storage technology, particularly digital video discs (DVD), have created the ability to store full length motion pictures on a single small disc. However, consumers are unlikely to benefit from such advances unless content providers have a mechanism to distribute digitized versions of their valuable copyrighted material in a manner that largely eliminates unauthorized copying.

It is possible to devise strong content protection schemes for securely transferring digital content between various devices. These schemes are often computationally intensive, although modern PCs and customized hardware, typically have sufficient computational resources to perform these content protection schemes in a substantially real-time manner. However, in order to meet manufacturing cost targets, CE devices are often not equipped with the computational resources needed to implement strong content protection schemes in a substantially real-time manner.

Protecting digital content from copying and/or other misuse as that content is transferred between one or more computationally constrained devices over insecure communication links is desirable. Large investments in the development and use of software have resulted in an ever increasing dependence on computing devices in today's society. The software has enabled the computing devices to be increasingly used to conduct valuable transactions, and to generate or access sensitive, private, personal, or business information. This makes the computing devices attractive targets for sabotage, espionage, cyber-crime, hacking, or other malicious behavior. Such behavior is intended to cause operational problems, create security problems, or enable criminal activities.

As the use of computing devices to perform critical business transactions and activities proliferate, computing devices are increasingly becoming the subjects of unwanted attacks. A common method for attacking the computing devices is to compromise the integrity (e.g., by modifying or substituting) the operating system and/or application software that enable the computing device to function correctly.

One such method is a secret substitution of existing software with modified software designed to compromise confidential data and information stored on the computing device. The modified software may perform the functions of the prior, replaced software, while secretly (e.g., as a background process) compromising confidential data and information. For example, the modified software may compromise confidential and sensitive information (i.e., a credit card number, a password, etc.). The modified software may also transmit this compromised information to another computer over a network, where that information is subsequently used to conduct unauthorized business transactions. Because the modified software is likely to perform the functions of the replaced software while secretly compromising the data, a user may likely remain unaware of the damage, possibly indefinitely.

Another method for compromising the integrity of the software may include a computer virus. A virus may be introduced into a computing device through mechanisms such as a floppy drive coupled to the computing device, a network connection, a modem connection, etc. The virus typically infects the computing device by attaching itself to one or more programs of the computing device. When the user subsequently executes the affected program, confidential data and/or information on the computing device may be compromised and/or destroyed.

One common method of verifying software integrity is the execution of a virus checking software program on the computing device. However, this method may depend on the characteristics of the virus to detect the virus′ presence and, thus, may not detect a new virus with new characteristics. Additionally, a virus checking software program may be software-based, the virus checking software program itself may be modified or overwritten (i.e., the virus checking software program itself may be susceptible to attack).

Another method of verifying software integrity utilizes “Checksums”. A Checksum is a type of integrity assessment code based on the number of set bits in the software program. For example, a CRC Checksum algorithm generates an integrity assessment code for a software program based on the number of set (i.e., “1”) bits in the software program. A Checksum may be calculated when a software program located on a computing device is initially installed (e.g., when a software program is known to be “good” or correct), and stored, along with the Checksum algorithm, on the computing device. Thereafter, the Checksum may be periodically calculated by the Checksum algorithm. For example, before executing the software program, the most recently calculated Checksum may be compared to the previously stored checksum to ensure integrity of the software program.

Checksums may be adequate for detecting accidental modifications to the software program. However, because of their simplicity, Checksums are not an adequate defense against a well designed virus or substitute software that may produce an identical Checksum. Furthermore, because a Checksum algorithm is not secure, a Checksum algorithm may be susceptible to attack.

There exists a need to protect the integrity of a software program thereby enabling computing devices properly perform their ever-increasing role in today's society. Conventional methods of verifying software integrity are themselves susceptible to being compromised. A method for validating the integrity of a software program that is not susceptible to being compromised is highly desirable.

### SUMMARY OF THE INVENTION

A system in accordance with the present invention prevents tampering of a device. The system includes an encrypted digital signature and a decryption attempt. The encrypted digital signature represents a configuration of the device and is in a non-volatile memory of the device. The decryption attempt is received from a source seeking access to the device. The system determines whether the digital signature matches the decryption attempt.

A method in accordance with the present invention prevents tampering of a device. The method comprises the following steps: creating an encrypted digital signature representing a hardware definition of the device and a state of the device; storing the digital signature in a non-volatile memory of the device; receiving a decryption attempt from a source seeking access to the device; and determining whether the digital signature matches the decryption attempt.

A computer program product in accordance with the present invention prevents tampering with a device. The product includes: a first instruction for creating an encrypted digital signature representing a hardware definition of the device and a state of the device; a second instruction for storing the digital signature in a non-volatile memory of the device; a third instruction for receiving a decryption attempt from a source seeking access to the device; and a fourth instruction for determining whether the digital signature matches the decryption attempt.

### BRIEF DESCRIPTIONOF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of part of a system in accordance with the present invention;

FIG. 2 is a schematic representation of another part of the system in accordance with the present invention;

FIG. 3 is a schematic flow diagram of the system of FIG. 1;

FIG. 4 is a schematic flow diagram of the system of FIG. 2; and

FIG. 5 is a schematic representation of a computer program product in accordance with the present invention.

### DESCRIPTION OF AN EXAMPLE EMBODIMENT

A system in accordance with the present invention may add a barrier to an anti-tamper package for minimal cost. This package may be performed with or without supporting hardware, making the package valuable for systems with finalized hardware that now have new anti-tamper requirements. Combined with optional support hardware, the system may cost an attacker or aggressor a large amount of time and money to overcome.

A system in accordance with the present invention may include symmetric encryption with a secure hash standard, SHA-1, combined with hardware and system state specific data to verify system integrity. Once implemented, the system detects (and reacts) if software has been modified, hardware has been modified, software has been copied to foreign hardware, and/or if the system has been previously powered-up while under tampering conditions. The system utilizes SHA-1 and encryption/decryption techniques for providing a “seal” from the inside (mathematically). The result is an “Anti-Tamper Barrier” having a high benefit vs. cost ratio. Additional support hardware may optionally enhance the system, thereby increasing an aggressor's cost for tampering.

A Secure Hash Algorithm, SHA-1, computes a condensed representation of a message or a data file. When a message of any length <2⁶⁴ bits is input into SHA-1, SHA-1 may produce a 160-bit output called a message digest. The message digest may then be input into a Digital Signature Algorithm (DSA), which generates or verifies a signature for the message digest. Providing a signature for the message digest, rather than the message, may improve the efficiency of the system because the message digest is usually much smaller in size than the message. SHA-1 may also be used by a verifier of a digital signature just as SHA-1 was used by the creator of the digital signature.

SHA-1 is secure because SHA-1 matching a message with its corresponding message digest is computationally infeasible. Alternatively, revealing two different messages that produce the same message digest is also computationally infeasible. Any change to a message in transit will, with very high probability, result in a different message digest, and the signature will fail to verify.

SHA-1 may be used with a Digital Signature Algorithm in electronic mail, electronic funds transfer, software distribution, data storage, and other applications which require data integrity assurance and original data authentication. SHA-1 may also be used for generating a condensed version of a message.

SHA-1 may be implemented in software, firmware, hardware, or any combination thereof. SHA-1 may specify a secure hash algorithm and encourage the adoption and use of a specified secure hash algorithm by any private or commercial organizations.

SHA-1 may be required for use with a Digital Signature Algorithm (DSA) specified in a Digital Signature Standard (DSS) and whenever a secure hash algorithm is required. As stated above, for a message of length <2ˆ64 bits, SHA-1 may produce a 160-bit condensed representation of the message called a message digest. The message digest is used during generation of a signature for the message. SHA-1 may also compute a message digest for the received version of the message during the process of verifying the signature. Any change to the message in transit will, with very high probability, result in a different message digest, and the signature will fail to verify.

The system in accordance with the present invention may utilize the following terminology related to bit strings and integers. A hex digit is an element of the set {0, 1, . . . 9, A, . . . , F}. A hex digit is the representation of a 4-bit string (i.e., 7=0111, A=1010, etc.). A word equals a 32-bit string which may be represented as a sequence of 8 hex digits. To convert a word to 8 hex digits, each 4-bit string is converted to its hex equivalent as described above (i.e., 1010 0001 0000 0011 1111 1110 0010 0011=A103FE23, etc.). An integer between 0 and 2³²-1, inclusive, may be represented as a word. The least significant four bits of an integer may be represented by the right-most hex digit of the word representation (i.e., the integer 291=2⁸+2⁵+2¹+2⁰=256+32+2+1 is represented by the hex word 00000123, etc.).

If z is an integer and 0<=z<2⁶⁴, then z=2³²x+y where 0 <=z<2³² and 0<=y<2³². Since x and y can be represented as words X and Y, respectively, z can be represented as the pair of words (X, Y). Block =512-bit string. A block (e.g., B) may be represented as a sequence of 16 words.

The system may apply the following logical operators to words: Bitwise logical word operations; X ˆ Y=bitwise logical “and” of X and Y; X\/Y=bitwise logical “inclusive-or” of X and Y; X XOR Y=bitwise logical “exclusive-or” of X and Y; and ˜ X=bitwise logical “complement” of X.

### Example

$$XOR = \frac{\begin{matrix}01101100101110011101001001111011 \\ 01100101110000010110100110110111\end{matrix}}{00001001011110001011101111001100}$$

The operation X+Y may be defined as follows: words X and Y represent integers x and y, where 0<=x<2³² and 0<=y<2³². For positive integers n and m, let n mod m be the remainder upon dividing n by m. Compute z=(x+y)mod 2³². Then 0<=z<2³². Convert z to a word, Z, and define Z=X+Y. The circular left shift operation Sⁿ(X), where X is a word and n is an integer with 0<=n³², may be defined by Sⁿ(X)=(X<<n) OR (X>>32-n).

X<<n may be obtained by discarding the leftmost n bits of X and then pad the results with n zeroes on the right (the result will still be 32 bits). X>>n may be obtained by discarding the rightmost n bits of X and then padding the result with n zeroes on the left. Thus, Sⁿ(X) is equivalent to a circular shift of X by n positions to the left.

SHA-1 computes a message digest for a message or data file that is provided to SHA-1 as input. The message or data file is considered to be a bit string. The length of the message is the number of bits in the message (the empty message has length 0). If the number of bits in a message is a multiple of 8, for compactness, SHA-1 may represent the message in hex. The purpose of message padding is to make the total length of a padded message a multiple of 512. SHA-1 sequentially processes blocks of 512 bits when computing a message digest.

The following specifies how this padding shall be performed. As a summary, a “1” followed by m “0”s followed by a 64-bit integer may be appended to the end of the message to produce a padded message of length 512*n. The 64-bit integer is 1, the length of the original message. The padded message is then processed by SHA-1 as n 512-bit blocks.

For example, a message may have length L<2⁶⁴. Before the message is input to SHA-1, the message is padded on the right as follows: “L” is appended, if the original message is “01010000”, the message is padded to “01010000 L”. “0”s are appended, the number of “0”s will depend on the original length of the message. The last 64 bits of the last 512-bit block may be reserved for the length L of the original message. If the original message is the bit string 01100001 01100010 01100011 01100100 01100101, after L is appended, 01100001 01100010 01100011 01100100 01100101. Since L=40, the number of bits in the above is 41 and 407 “0's are appended, making the total now 448.

This gives (in hex)

$$\begin{matrix}61626364 & 65800000 & 00000000 & 00000000 \\ 00000000 & 00000000 & 00000000 & 00000000 \\ 00000000 & 00000000 & 00000000 & 00000000 \\ 00000000 & 00000000. & & \end{matrix}$$

A 2-word representation of L is obtained, the number of bits in the original message. If L<2³², then the first word is all zeroes. Append these two words to the padded message.

If the original message is 01100001 01100010 01100011 01100100 01100101, as above, then L=40 (note that L is computed before any padding). The two-word representation of 40 is hex 000000000 00000028. Hence, the final padded message is hex

$$\begin{matrix}61626364 & 65800000 & 00000000 & 00000000 \\ 00000000 & 00000000 & 00000000 & 00000000 \\ 00000000 & 00000000 & 00000000 & 00000000 \\ 00000000 & 00000000 & 00000000 & 00000028.\end{matrix}$$

The padded message will contain 16* n words for some n>0. The padded message is regarded as a sequence of n blocks M₁, M₂, . . . , Mₙ, where each Mᵢ contains 16 words and M₁ contains the first characters (or bits) of the message.

A sequence of logical functions f₀, f₁, . . . , f₇₉ may be used by SHA-1. Each f₁, 0<=t<=79, may operate on three 32-bit words B, C, D and produce a 32-bit word as output. f₁(B, C, D) may be defined as follows: for words B, C, D:
fₜB,C,D)=(B AND C) OR ((NOT B) AND D) (0<=t<=19
fₜ(B,C,D)=B XOR C XOR D (20<=t<=39)
fₜ(B,C,D)=(B AND C) OR (B AND D) OR (C AND D) (40<=t<=59)
fₜ(B,C,D)=B XOR D(60<=t<=79).

A sequence of constant words K(0), K(1), . . . , K(79) may used by SHA-1. In hex, these constant words may be given by
K=5A827999 (0<=t<=19)
Kₜ=6ED9EBA1 (20<=t<=39)
Kₜ=8F1BBCDC (40 <=t<=59)
Kₜ=CA62C1D6 (60<=t<=79).

The message digest may be computed using a final padded message. The computation may use two buffers, each consisting of five 32-bit words, and a sequence of eighty 32-bit words. The words of the first 5-word buffer may be labeled A,B,C,D,E. The words of the second 5-word buffer may be labeled H₀, H₁, H₂, H₃, H₄. The words of the 80-word sequence may be labeled W₀, W₁, . . . , W₇₉. A single word buffer TEMP may also be employed.

To generate a message digest, the 16-word blocks M₁, M₂,. . . , Mₙ defined above may be processed in order. The processing of each Mᵢ may involve 80 steps. Before processing any blocks, the {Hᵢ} are initialized as follow: in hex,
H₀ =67452301
H₁=EFCDAB89
H₂=98BADCFE
H₃=10325476
H₄=C3D2E1F0

Now M₁, M₂, . . . , Mₙ may be processed. To process M₁, the system proceeds as follows:
a. Divide Mᵢ into 16 words W₀, W₁, . . . W₁₅, where W₀ is the leftmost word.
b. For t=16 to 79, let Wₜ=S¹(Wₜ₋₃XOR Wₜ₋₈ XOR Wₜ₋₁₄ XOR Wₜ₋₁₆).
c. Let A=H₀, B=H₁, C=H₂, D=H₃, E=H₄.
d. For t=0 to 79 do
   TEMP=S⁵(A)+fₜ(B,C,D)+E+Wₜ+Kₜ; E=D; D=C; C=S³⁰(b); B=A; A=TEMP;
e. Let H₀=H₀+A, H₁=H₁+B, H₂+C, H₃=H₃+D, H₄=H₄+E. After processing Mₙ, the message digest is the 160-bit string represented by the 5 words H₀, H₁, H₂, H₃, H₄.

The above computation of the message digest assumes that the sequence W₀, . . . , W₇₉ is implemented as an array of eighty 32-bit words. This is efficient from the standpoint of minimization of execution time, since the addresses of Wₜ₋₃, . . . , Wₜ₋₁₆ above may be easily computed. If space is at a premium, an alternative computation may include regarding {Wₜ} as a circular queue, which may be implemented using an array of sixteen 32-bit words W[0], . . . W[15]. In this case, in hex, let MASK=0000000F. Then processing of Mᵢ may be as follows:
a. Divide Mᵢ into 16 words W[0], . . . , W[15], where W[0] is the leftmost word.
b. Let A=H₀, B=H₁, C=H₂, D=H₃, E=H₄.
c. For t=0 to 79 do
   s=tˆ MASK;
   if (t>=16) W[s]=S¹(W[(s+13)ˆMASK]XOR W[(s+8) AND MASK] XOR W{(s+2)ˆMASK] XOR W[s]);
   TEMP=S⁵(A)+fₜ(B,C,D)+E+W[s]+Kₜ; E=D; D=C; C=S³⁰(B); B=A; A−TEMP;
d. Let H₀=H₀+A, H₁=H₁+B, H₂+C, H₃=H₃+D, H₄+E

Both above computations yield the same message digest. Although using the alternative computation saves sixty-four 32-bit words of storage, the alternative computation is likely to lengthen execution time due to the increased complexity of the address computations for {W[t]}. Other computations, which give identical results, may be implemented in conformance with an appropriate standard.

Anti-Tamper systems are typically not a solution. Anti-Tamper systems buy time. If an aggressor expends a large amount of time, the target software/data will likely be outdated by the time the software/data is compromised. In addition, if the cost of tampering/reverse engineering costs more than the target software/data, then the aggressor will likely not continue.

The system in accordance with the present invention may be implemented by software only. This is desirable since many requirements are just now receiving Anti-Tamper specifications after hardware has been finalized. Furthermore, the system links a specific load of software to a given piece of hardware and a system state (such as altitude).

In modern encryption, an algorithm cannot be broken through mathematical means. Without a weakness in an encryption algorithm, the straightest path for an aggressor is either the location of the key for decryption, or a brute force attack. In a brute force attack, every possible key is attempted on the encrypted data. With 160 bit encryption, this is 1.4615016373309029182036848327163e+48 possible keys. Therefore, an attacker will likely search for the key to decryption, which may be present on the system.

The system in accordance with the present invention provides a solution to the “hide the key” problem by making the digital fingerprint of the system the actual key for decryption. In performing successful decryption, the software, hardware, and system state may be verified as well as the encrypted sensitive data being made available. Two birds are killed with one stone. If the system has been tampered with (either software modified, hardware, or system state bits are wrong) then the software will identify this tampering through unsuccessful decryption, thus keeping the sensitive data safe.

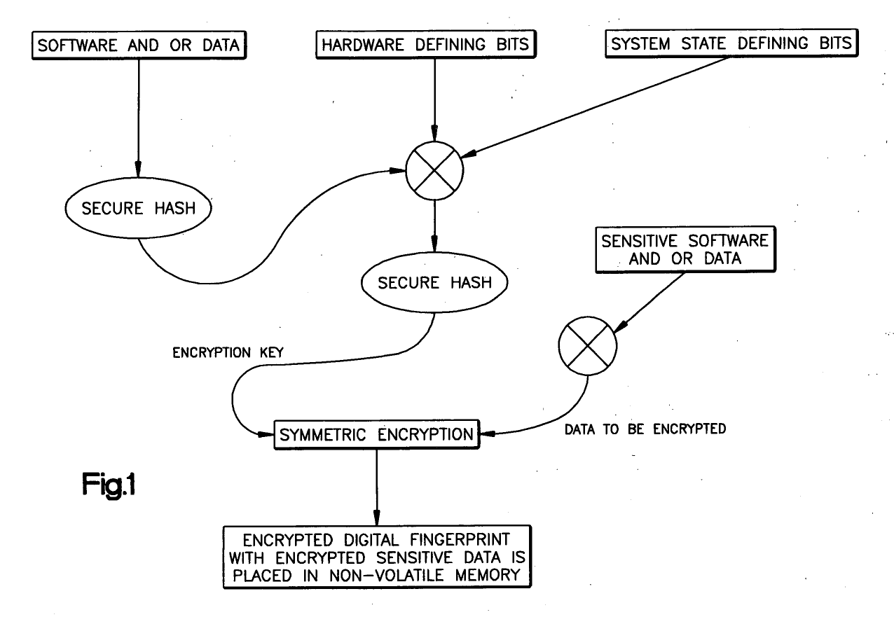

The system creates an encrypted digital signature of the system configuration (FIG. 1):
SH=secure hash (S)
SF=secure hash (SH+T)
SFL=(SF+L)
SE=symmetric encryption of (SFL, SF)
SE is placed in non-volatile memory.
SH is the secure hash of the whole software load to be verified.
T is a collection of bits that represent the system state and present hardware. System state and hardware bits may include, but are not limited to, JTAG enabled bits, minimum altitude bits, Ethernet Mac address bits, and weight of wheels bits.
SF is the secure hash of SH, and T
SFL is SF plus load L. The load L can be sensitive data or code, not to be exposed unless tamper not detected.
SE is the encrypted value of SFL using SF as the symmetric key.

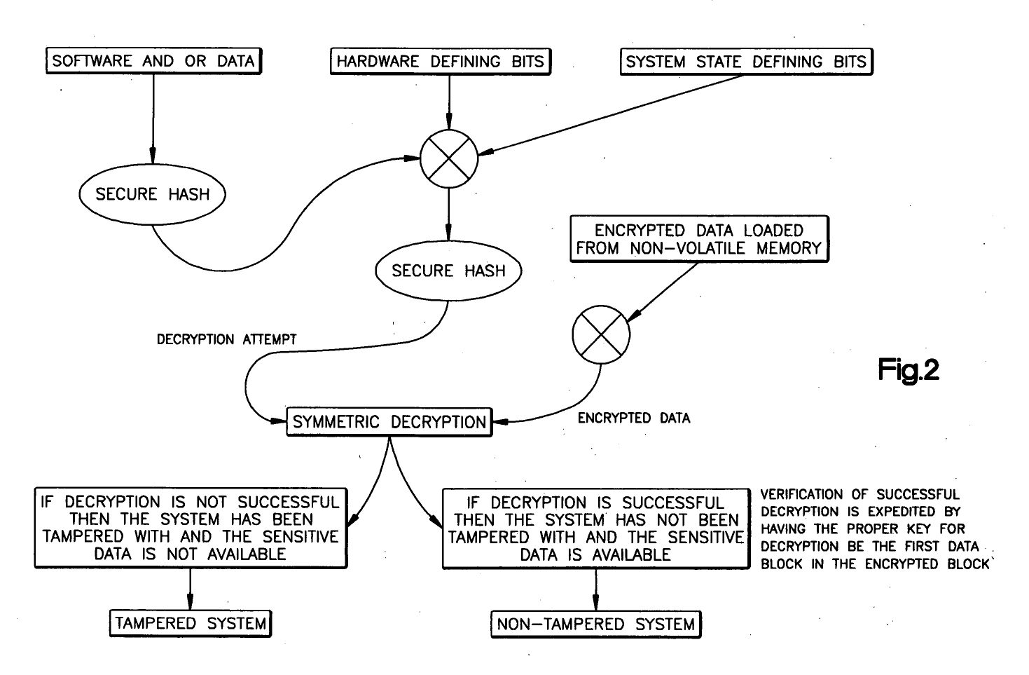

The system performs verification of software, hardware, and system state in the field (FIG. 2):
Collection of hardware and system state bits T from various sources.
SH is calculated using secure hash of the software load S.
SF is computed using secure hash of (SH, T).
SE is loaded from non-volatile memory.
SF′ is parsed from SFL from the symmetric decryption of SE using SF as key.
If SF′ does not equal SF then:
   1) Software has been modified. AND/OR
   2) System state bits are wrong. AND/OR
   3) Hardware has changed or software is not loaded on different hardware. THEN
   4) The software load L has been decrypted wrong, and is not available to prospective attacker.
The system may now take action in software (and/or hardware) since tampering has not been detected.

The system combines a digital fingerprint of a chosen piece of software (shown above as S) with hardware or system state data to create another digital fingerprint (shown above as SF). The system combines this fingerprint with optional sensitive data or code (shown above as SFL) and encrypts the fingerprint using the final digital fingerprint previously calculated (shown above as SF). The system places this final encrypted data in a non-volatile memory (shown above as SE).

The code for verification in the field should be redundant (perhaps during startup and in operational software) to increase the probability of tamper detection. Under normal (non-tamper) circumstances, the software/data is unmodified, the hardware is original and in a proper state, and the system state bits are identical to the bits used for creation of the digital signature key (shown above as SF). If and only if all these conditions are met may the system successfully decrypt the encrypted data, thus allowing access to the sensitive data payload (shown above as L). In addition, the proper fingerprint required for decryption may be exposed (after decryption) for quick verification of valid decryption and thus positive verification of the software, hardware, and system state.

A system in accordance with the present invention may be implemented in software only, making the system extremely valuable for finalized hardware later receiving anti-tamper requirements. In addition, custom hardware may be added for additional system state bits or for providing active reaction to tamper detection. These additions enhance the anti-tamper barrier, buying even more time against an aggressor. Overall, the system provides a very cost effective and robust anti-tamper barrier.

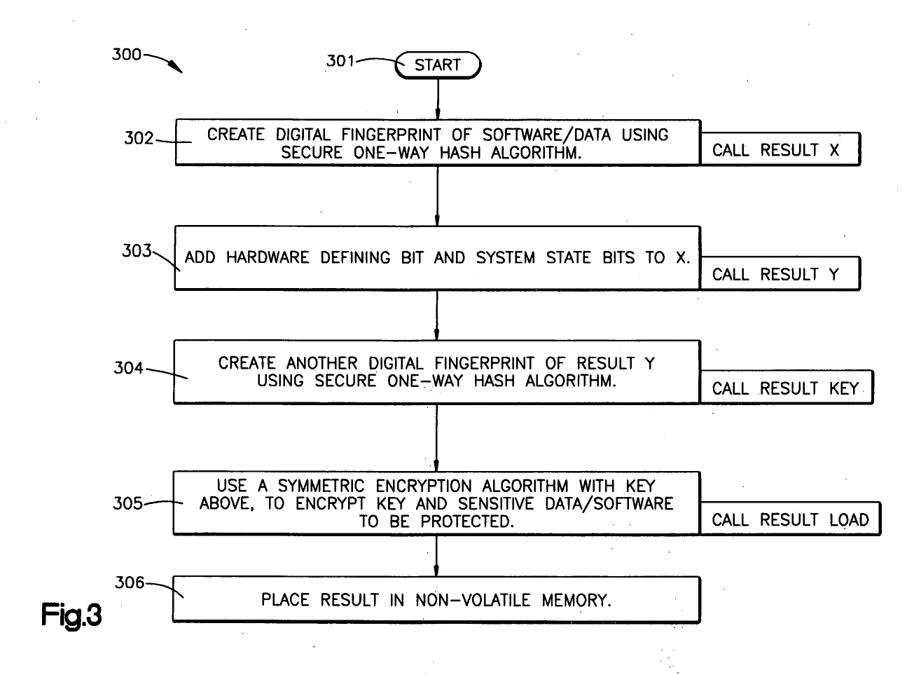

As illustrated in FIG. 3, an example system 300 in accordance with the present invention may create a secure device. Typically, the steps of FIG. 3 would be conducted prior to the device being implemented. In step 301, the system 300 is initiated. Following step 301, the system 300 proceeds to step 302. In step 302, the system 300 creates a digital fingerprint of the software/data of the device using a secure one-way hash algorithm. The system 300 reads all code/data to be secured and then executes a one-way secure hash algorithm such as SHA-1, described above. The output of step 302 may be X. X will typically be a fingerprint of 128 bits or more (depending on the secure hash algorithm used). Following step 302, the system 300 proceeds to step 303. In step 303, the system 300 adds hardware defining bits (such as the unique CPU ID or ETHERNET MAC address) and system state bits (such as weight) of the device to X. The hardware defining bits are used to determine if the device hardware has been tampered with or attacked (i.e., software running of foreign hardware, etc.). The system state defining bits are used to determine if the device state is considered invalid (such as being probed by an attacker). The output of step 303 may be Y.

Following step 303, the system 300 proceeds to step 304. In step 304, the system 300 creates a digital fingerprint of Y using the secure one-way hash algorithm. The output of step 304 may be KEY. Following step 304, the system 300 proceeds to step 305. In step 305, the system 300 uses a symmetric encryption algorithm with KEY to encrypt KEY and the data/software (other than from step 302). The output of step 305 may be LOAD. Following step 305, the system 300 proceeds to step 306. In step 306, the system 300 places LOAD in a non-volatile memory of the device. The device is now safe for implementation.

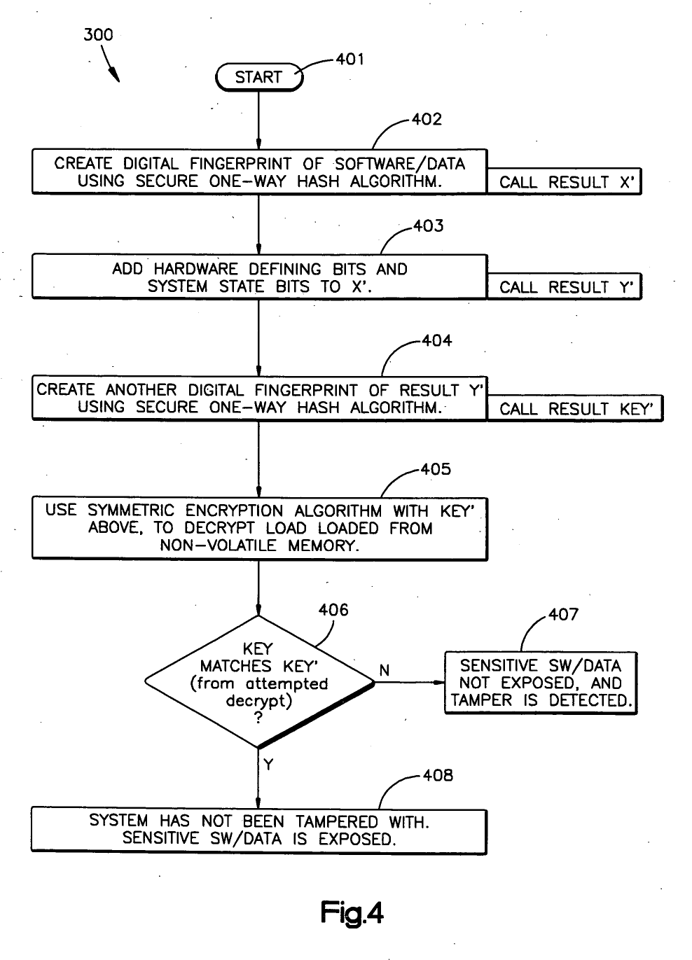

As illustrated in FIG. 4, the example system 300 in accordance with the present invention may verify the integrity of the device being protected. The system 300 executes software to determine if the system has been tampered with from a hardware, software, or device state perspective. As illustrated in FIG. 3, there is no “hidden key” for an attacker to locate and use for decryption. The steps of FIG. 4 may be executed in a friend environment or a foe environment. In step 401, the system 300 is initiated. Following step 401, the system 300 proceeds to step 402. In step 402, the system 300 creates a digital fingerprint of the software/data of the device using a secure one-way hash algorithm. The system 300 reads all code/data to be secured and then executes a one-way secure hash algorithm such as SHA-1 described above. The output of step 402 may be X′. X′ will typically be a fingerprint of 128 bits or more (depending on the secure hash algorithm used).

Following step 402, the system 300 proceeds to step 403. In step 403, the system 300 adds hardware defining bits (such as a unique CPU ID or ETHERNET MAC address) and system state bits (such as weight) of the device to X′. The hardware defining bits are used to determine if the device hardware has been tamper with or attacked. The system state defining bits are used to determine if the device state is considered invalid (such as being probed by an attacker). The output of step 403 may be Y′.

Following step 403, the system 300 proceeds to step 404. In step 404, the system 300 creates a digital fingerprint of Y′ using the secure one-way hash algorithm. The output of step 404 may be KEY′. Following step 404, the system 300 proceeds to step 405. In step 405, the system 300 uses a symmetric encryption algorithm with KEY′ to decrypt LOAD from the non-volatile memory of the device.

Following step 405, the system 300 proceeds to step 406. In step 406, the system 300 compares KEY′ to KEY. If KEY′ does not match KEY, the system 300 proceeds to step 407. In step 407, the system 300 has detected tampering and conceals the software/data of the device. If KEY′ matches KEY in step 406, the system 300 proceeds to step 408. In step 408, the system 300 exposes the software/data of the device.

An example method 300 in accordance with the present invention (FIGS. 3 & 4) prevents tampering of a device. The method 300 comprises the following steps: creating 302 an encrypted digital signature representing a hardware definition of the device and a state of the device; storing 306 the digital signature in a non-volatile memory of the device; receiving 402 a decryption attempt from a source seeking access to the device; and determining 406 whether the digital signature matches the decryption attempt.

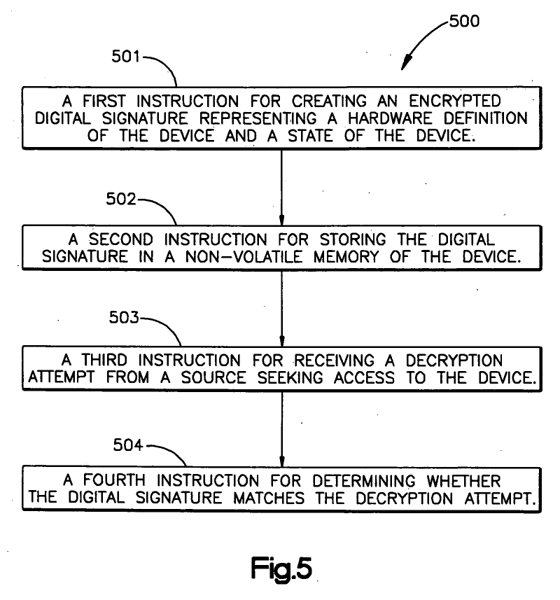

A computer program product 500 in accordance with the present invention (FIG. 5) prevents tampering with a device. The product 500 includes: a first instruction 501 for creating an encrypted digital signature representing a hardware definition of the device and a state of the device; a second instruction 502 for storing the digital signature in a non-volatile memory of the device; a third instruction 503 for receiving a decryption attempt from a source seeking access to the device; and a fourth instruction 504 for determining whether the digital signature matches the decryption attempt.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations,. and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for preventing tampering of a device, said system comprising:
an encrypted digital signature representing a configuration of the device, said digital signature being placed in a non-volatile memory of the device; and
a decryption attempt received from a source seeking access to the device,
said system determining whether said digital signature matches said decryption attempt.

2. The system as set forth in claim 1 wherein said digital signature includes a hardware definition of the device and a state of the device.

3. The system as set forth in claim 1 wherein said digital signature includes a 160-bit representation.

4. The system as set forth in claim 1 wherein said digital signature is created utilizing a secure one-way hash algorithm.

5. The system as set forth in claim 1 wherein said system denies access to the device if said digital signature does not match said decryption attempt.

6. The system as set forth in claim 1 wherein said system allows access to the device if said digital signature matches said decryption attempt.

7. The system as set forth in claim 1 wherein said digital signature is created by linking a load of software from the device to a hardware configuration of the device.

8. The system as set forth in claim 1 wherein said digital signature is created by linking a load of software from the device to a relative state of the device.

9. The system as set forth in claim 1 wherein said digital signature is created by linking a load of software from the device to a hardware configuration of the device and a relative state of the device.

10. The system as set forth in claim 1 further including hardware for actively reacting to tamper detection.

11. A method for preventing tampering of a device, said method comprising the following steps:
creating an encrypted digital signature representing a hardware definition of the device and a state of the device;
storing the digital signature in a non-volatile memory of the device;
receiving a decryption attempt from a source seeking access to the device; and
determining whether the digital signature matches the decryption attempt.

12. The method as set forth in claim 11 further including the step of creating the digital signature by utilizing a secure one-way hash algorithm.

13. The method as set forth in claim 11 further including the step of denying access to the device if the digital signature does not match the decryption attempt.

14. The method as set forth in claim 11 further including the step of allowing access to the device if the digital signature matches the decryption attempt.

15. The method as set forth in claim 11 further including the step of linking a load of software from the device to a hardware configuration of the device.

16. A computer program product for preventing tampering of a device, said product comprising:
a first instruction for creating an encrypted digital signature representing a hardware definition of the device and a state of the device;
a second instruction for storing the digital signature in a non-volatile memory of the device;
a third instruction for receiving a decryption attempt from a source seeking access to the device; and
a fourth instruction for determining whether the digital signature matches the decryption attempt.

17. The computer program product as set forth in claim 16 further including a fifth instruction for denying access to the device if the digital signature does not match the decryption attempt.

18. The computer program product as set forth in claim 16 further including a fifth instruction for allowing access to the device if the digital signature does match the decryption attempt.

19. The computer program product as set forth in claim 16 wherein said first instruction includes an instruction for linking a load of software from the device to a hardware configuration of the device.

20. The computer program product as set forth in claim 16 wherein said first instruction includes an instruction for linking a load of software from the device to a relative state of the device.
